(19) United States
(12) Patent Application Publication
(10) Pub. No.: US 2025/0374043 A1
(43) Pub. Date: Dec. 4, 2025

(54) COMBINING SUBSCRIBER DATA MANAGEMENT COMPONENTS INTO A SINGLE COMPONENT

(71) Applicant: Microsoft Technology Licensing, LLC, Redmond, WA (US)

(72) Inventors: Edmund Richard James PRINGLE, London (GB); Keith Stuart WANSBROUGH, Brightons (GB)

(21) Appl. No.: 18/677,702

(22) Filed: May 29, 2024

(51) Int. Cl. H04W 12/06; H04W 76/14; H04W 8/18

(52) U.S. Cl. CPC H04W 12/06; H04W 76/14; H04W 8/18

(57) ABSTRACT

The present disclosure generally relates to combining network management functions onto a single component. Systems described herein involve combining an authentication component, a data management component, and a data repository component into a single combined subscriber data management function. In one or more examples, the combined subscriber data management function logically combines the functionality of all three components while maintaining an appearance to external network members that the three components are physically separate. In this manner, the systems described herein reduce the network bandwidth previously utilized as the three components communicated among each other without requiring any changes or modifications by external members of the network.

### FIELD OF TECHNOLOGY

This disclosure relates to combining complex network management functions into a single component. More specifically, this disclosure pertains to combining three network management functions in a way that masks their combination and makes it appear to external components as though the combined functions are actually separate.

### BACKGROUND

Cellular networks can provide computing devices (e.g., mobile devices) with access to services available from one or more data networks. A cellular network is typically distributed over geographical areas that include one or more base stations and core network devices that provide a cell with network coverage. The devices of the cellular network provide reliable access to a data network by mobile devices over a wide geographic area. In many instances these cellular networks provide mobile devices access to the cloud.

As noted above, cellular networks include a number of network components. For example, cellular networks often include a radio access network (RAN) and a core network. The RAN may include base stations that communicate wirelessly with user devices (e.g., mobile devices) and facilitate interaction with components of a core network. The core network may provide access to services and data available from one or more external networks. As noted above, cellular networks are often used to provide Internet connectivity to mobile devices.

As will be discussed in further detail herein, a core network may provide a variety of functions, including functions and services that provide Internet protocol (IP) connectivity for both data and voice services, ensuring this connectivity fulfills the promised QoS requirements, ensuring that user devices are properly authenticated, tracking user mobility to ensure uninterrupted service, and tracking subscriber usage for billing and charging.

The variety of functions provided by the core network are often distributed across multiple separate components (e.g., physical servers). It follows that, in providing such functionality, these distributed components become heavy network bandwidth users as messages are transmitted among components. In many instances, this messaging results in unnecessary network hops and lookups as each individual component often has its own interface and functionality. Overall, the distributed nature of components and services within the core network frequently results in a wide range of inefficiencies and wasted network resources.

The subject matter in the background section is intended to provide an overview of the overall context for the subject matter disclosed herein. The subject matter discussed in the background section should not be assumed to be prior art merely as a result of its mention in the background section. Similarly, a problem mentioned in the background section or associated with the subject matter of the background section should not be assumed to have been previously recognized in the prior art.

### BRIEF DESCRIPTION OF THE DRAWINGS

FIG. 1 illustrates an example telecommunications network environment including a combined subscriber data management function implemented within a core network.

FIG. 2 illustrates the combined subscriber data management function implemented on a single server device in accordance with one or more embodiments.

FIG. 3 illustrates a sequence diagram illustrating steps taken by components of the combined subscriber data management function during authentication of a user equipment in accordance with one or more embodiments.

FIG. 4 illustrates an example series of acts for leveraging the combined functionality of the components of the combined subscriber data management function in accordance with one or more embodiments.

FIG. 5 illustrates certain components that may be included within a computer system.

### DETAILED DESCRIPTION

The present disclosure relates to systems, methods, and computer-readable media for combining multiple network management functions into a single component. For example, and as will be discussed in greater detail below, the systems, methods, and computer-readable media discussed herein include a combined subscriber data management function that combines the features and functionality of an authentication component (e.g., functionality of an authentication server function (AUSF)), a data management component (e.g., a unified data management function (UDM)), and a data repository component (e.g., a user data repository function (UDR)) within a core network of a larger telecommunications network into a single component or process. In one or more implementations, the combined subscriber data management function embodies communication interfaces for each of the authentication component, the data management component, and the data repository component that allow these components to communicate with each other internally while maintaining the appearance of being physically separate to other external components of both the core network and other user equipments.

As a first illustrative example, an authentication component of the combined subscriber data management function (e.g., in a core network of a 5G mobile communication network) receives a request from a user equipment to establish a network session via a session management function (SMF) of the core network. In response to this request, a data management component of the combined subscriber data management function generates an authentication challenge, which the authentication component then transmits to the user equipment. The user equipment generates and transmits a challenge response back to the authentication component via the SMF. The authentication component then compares the challenge response from the user equipment to a key that is associated with the authentication challenge. If the challenge response correctly correlates with the key, the authentication component registers the UE with the core network thereby establishing the network session between the user equipment and the core network.

In one or more implementations, the user equipment may only communicate with the combined subscriber data management function via the authentication component until the user equipment is registered with the core network and the network session is established. Once the network session is established, the user equipment may communicate with the data management component of the combined subscriber data management function, the data repository component of the combined subscriber data management function directly, and/or any other additional network function within the core network without having to go through the authentication component (e.g, the AUSF component) of the combined subscriber data management function. Moreover, the combined subscriber data management function integrates and maintains communication interfaces for each of the authentication component, the data management component, and the data repository component that allows such direct communication with each component by the user equipment. In one or more implementations, the combined subscriber data management function maintains the separate communication interfaces for the authentication component, the data management component, and the data repository component such that all three components can accurately report individual usage metrics and other data.

As will be discussed herein, the present disclosure includes a number of practical applications having features described herein that provide benefits and/or solve problems associated with managing communication sessions that take place over a telecommunications network. It will be appreciated that benefits discussed herein are provided by way of example and are not intended to be an exhaustive list of all possible benefits of the management system(s) described herein.

In one or more implementations, the combined subscriber data management function enables improved network resource efficiency in multiple ways. For example, by combining authentication, data management, and data repository functionalities into a single component, the combined subscriber data management function reduces or eliminates messaging between what were previously separate components on separate physical servers within the core network. As such, the authentication component, the data management component, and the data repository component utilize less network bandwidth and perform fewer network hops and network lookups by communicating directly via function calls within the combined subscriber data management function as part of a single server process.

Furthermore, the combined subscriber data management function includes an integrated communication interface that reflects the separate communication interfaces of each of the authentication component, the data management component, and the data repository component of the combined subscriber data management function. In one or more implementations, this integrated communication interface enables other members of the core network and user equipments to communicate with each of the authentication component, the data management component, and the data repository component as though these components were physically separate. As such, the combined subscriber data management function combines these components in a way that is transparent to other members of the core network and user equipments, so that these external components and user equipments require no modification and remain in compliance with applicable standards.

Additionally, the combined subscriber data management function successfully combines the functionality of the authentication component, the data management component, and the data repository component without adversely affecting the scalability of all three components. For example, when the authentication component, the data management component, and the data repository component are separately located on separate servers distributed across the core network, scaling one component often impacts the functionality of the other two components. In the least, it has been found that one or more embodiments of the authentication component, data management component, and the data repository component having the features and functionalities described herein will often scale commensurately with one another as increased demand on one of these respective components will often correlate with the other components of the combined subscriber data management function. As such, scaling one component at a time often results in time and resources being spent in maintaining the functionality of the other two components.

By combining all three components into one server process, the combined subscriber data management function ensures that communication interfaces between the three components can be quickly and effectively updated to reflect the scaling of one component without creating any additional burden on resources within the core network. Moreover, from a development standpoint, combining these multiple components into one server process means easier and faster code changes to address not only the capacity of the core network (e.g., scalability) but also the functionality of the core network. As such, when the functionality of one component changes in a way that effects the other two components within the combined subscriber data management function, changes can be quickly made to the other two components in a way that does not require sandboxing all three components to determine whether dependencies have broken, data is being lost, etc.

Moreover, the combined subscriber data management function increases the security of the core network by combining the authentication component, the data management component, and the data repository component. For example, by combining authentication, data management, and data repository functionality into a single component, the combined subscriber data management function eliminates the network messaging that previously occurred across servers associated with these functionalities within the core network. This previous level of messaging could lead to intercepted communications and unguarded messaging ports. As such, the combined subscriber data management function reduces the possibility that these vulnerabilities can be exploited by a bad actor.

As illustrated in the foregoing discussion and as will be discussed in further detail herein, the present disclosure utilizes a variety of terms to describe features and advantages of methods and systems described herein. Some of these terms will be discussed in further detail below.

As used herein, a “telecommunications network” refers to a group of interconnected nodes that facilitate the exchange of messages and signals. In one or more implementations, a telecommunications network includes nodes such as server devices that are connected by links (i.e., wired or wireless). Often, a telecommunications network includes sophisticated routing systems that move messages and signals among the nodes of the network. In one or more implementations, a telecommunications network as discussed herein includes a fifth generation (5G) mobile communication network.

As used herein, a “core network” refers to a backbone of nodes within a larger telecommunications network that is generally considered to be the most crucial part of the telecommunications network. Generally, a core network can include multiple layers. For example, a core network may include an access layer that connects user equipments with the telecommunications network, a distribution layer that connects the access layer with a core layer by providing routing and traffic management, and the core layer that handles connectivity and user services.

As used herein, “network management components” refer to telecommunication network components within the core network that manage various services and tasks. For example, and as will be discussed in greater detail below, network management components can include an authentication component, a data management component, and a data repository component. In one or more implementations, such network management components—and their associated functionality—may be combined into a single component, such as the combined subscriber data management function discussed herein. Each of these components will be discussed in further detail below by way of example and by definition.

For example, as used herein, the authentication component may serve as a component of the combined subscriber data management function tasked with handling authentication and/or encryption of communications between network elements and a user equipment (UE). For instance, the authentication component may perform functions such as registration management, access authentication, security context management and other authentication functions. In one or more embodiments, the authentication component shares similar features and functionality as an AUSF as defined by 3GPP standards.

As another example, as used herein, the data management component may serve as a component of the combined subscriber management function tasked with handling user or account subscription data within the telecommunications network. For instance, the data management component may handle functions related to maintaining or otherwise managing user profiles, storing and retrieving subscriber data, and providing access to the subscriber data to authenticated entities within the telecommunications network. In one or more embodiments, the data management component shares similar features and functionality as a UDM as defined by 3GPP standards.

As another example, as used herein, the data repository component may serve as a component of the combined subscriber management function tasked with handling additional user-related data storage and management data. For instance, the data repository component may store or otherwise maintain a converged repository of subscriber data including customer profile data, authentication information, encryption keys, and other subscriber-related data. In one or more embodiments, the data repository component shares similar features and functionality as a UDR as defined by 3GPP standards.

As used herein, a “network session” refers to a connection in which a user equipment (UE) or other endpoint device obtains a connection or access to or more services hosted by a network (e.g., a telecommunications network). In the context of one or more embodiments described herein, a network session refers to a real-time connection in which data is transmitted via components of a telecommunications network, such as between a UE and one or more components of the core network.

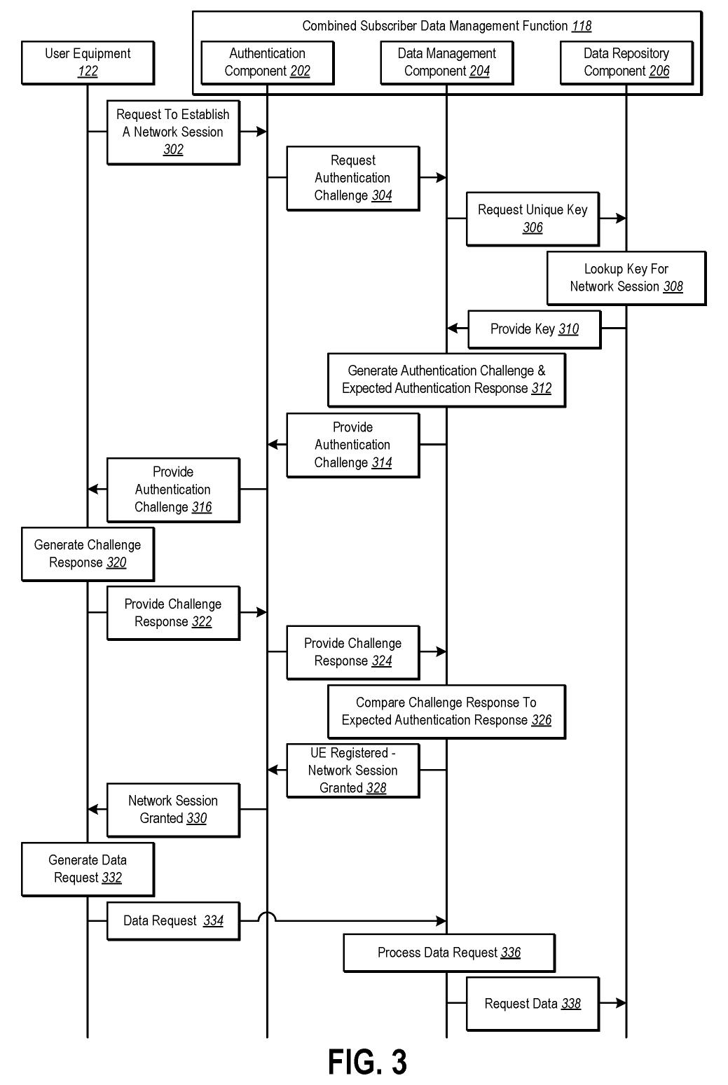

As part of registering a UE and establishing a network session between the UE and the core network, one or more implementations discussed herein include authentication steps that are issued and satisfied prior to the network session being established. For example, as used herein, an “authentication challenge” refers to a challenge generated and issued by the core network, while an “authentication response” refers to a response generated by a UE to the authentication challenge. In one or more implementations, both the authentication challenge and the authentication response are generated based on known and hidden values that enable both the UE and the core network to verify each other’s credentials. This is discussed in greater detail below with regard to FIG. 3.

As used herein, a “component” refers to a process of a network management server. For example, the component of a network management server can refer to a single operating system process. Such a process could include, for example, the communication protocols followed by that network management component, the data formatting utilized by that network management component, the services provided by that network management component, and so forth.

As used herein, a “communication interface” refers to a set of programming that enables two or more components—both internal and external to the core network—to communicate with each other. Often, network management components have different and/or unique communication interfaces such that communication between components may necessitate additional intermediary steps.

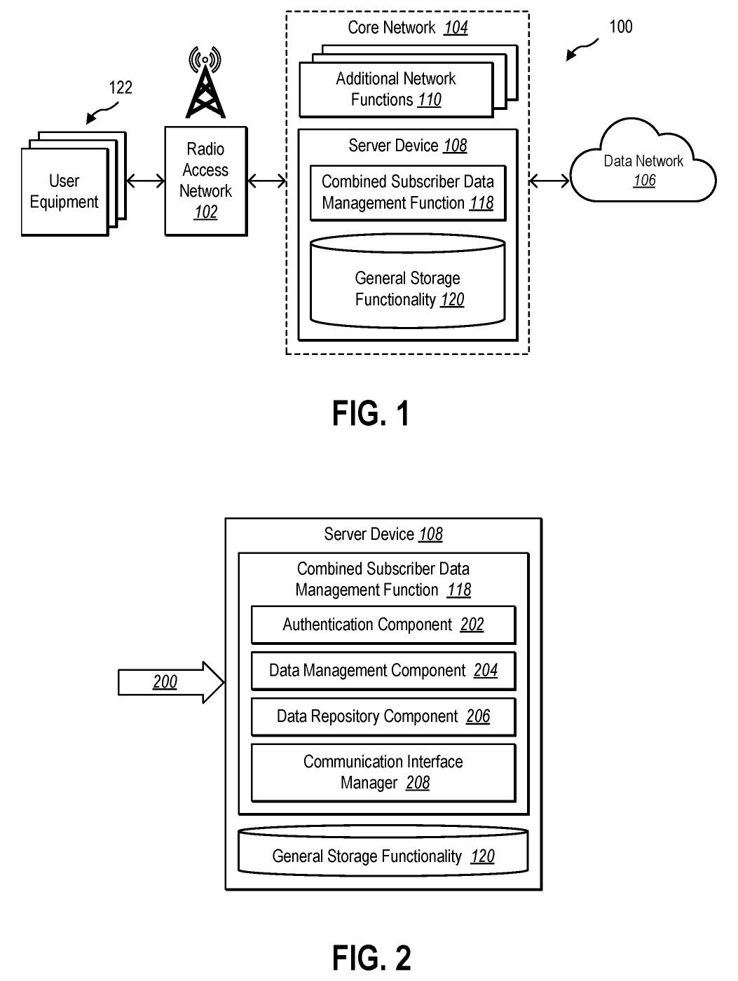

Additional details will now be provided regarding systems described herein in relation to illustrative figures portraying example implementations. For example, FIG. 1 illustrates an example environment 100 for implementing features and functionality of a combined subscriber data management function 118 implemented on a network device (e.g., a server device 108) within a core network 104 of a telecommunications network. As shown in FIG. 1, the environment 100 includes a radio access network 102 (RAN), the core network 104, and a data network 106. It will be appreciated that one or more features of the RAN 102, core network 104, and data network 106 may be implemented in whole or at least partially on a cloud computing system. For example, in one or more embodiments, portions of the RAN 102 may be virtualized on server nodes of the cloud computing system while some or all of the core network components may be implemented on server nodes of the cloud computing system. In one or more embodiments, portions of the RAN 102, core network 104, and/or data network 106 may be implemented at server devices that are located on an edge network having a closer proximity to the user equipments 122 than server devices at a centralized datacenter (e.g., to provide faster speed and optimized latency).

As shown in FIG. 1, core network 106 may include the server device 108 having the combined network function 118 and a general storage functionality 120. The server device 108 may be in communication with any number of additional network functions 110 (e.g., access and mobility management functions (AMFs), session management functions (SMFs), network repository functions (NRFs), network slice selection functions (NSSFs), and any other network functions commonly found in a core network). Each of the respective functions may be implemented on or across multiple server nodes.

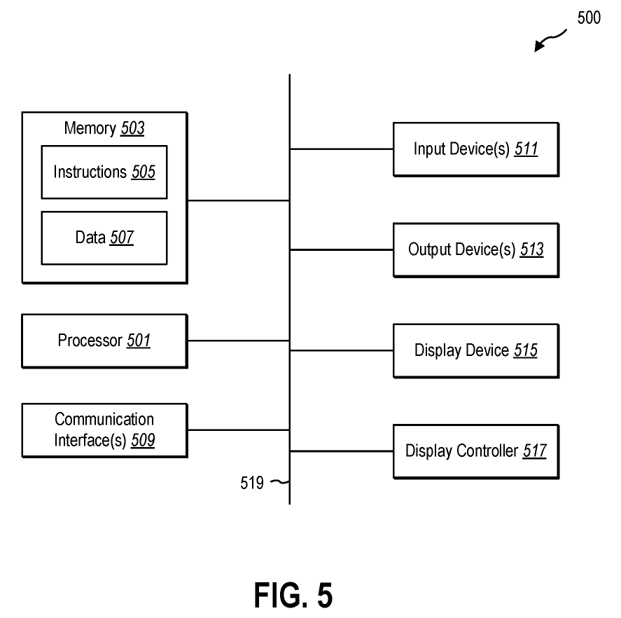

As shown in FIG. 1, the environment 100 may include a number of user equipments (UEs) 122. The UEs 122 may refer to a variety of computing devices or endpoints including, by way of example, a mobile device such as a mobile telephone, a smartphone, a personal digital assistant (PDA), a tablet, or a laptop. One or more of the UEs 122 may refer to non-mobile devices such as a desktop computer, a server device, an Internet of Things device, a router, or other non-portable devices that communicate with other endpoint devices via the telecommunications network. In one or more embodiments, the UEs 122 may refer to applications or software constructs on a computing device. Each of the devices of the environment 100 may include features and functionality described generally below in connection with FIG. 5.

As shown in FIG. 1, the UEs 122 may communicate with the core network 104 via the RAN 102. As mentioned above, one or more components of the environment 100 may be implemented within an architecture of a cellular network. For example, as noted above, a cellular network may include a radio access portion inclusive of a network of mobile towers (or base stations) in combination with components of a core network 104. Thus, as used herein, a cellular network may refer broadly to an architecture inclusive of the radio access network 102 including the mobile towers and computing nodes of the core network 104.

Each of the UEs 122, the RAN 102, and components of the core network 104 may communicate via one or more networks. These networks may include one or more communication platforms or any technology for transmitting data. For example, a network may include the Internet or other data link that enables transport of electronic data between the UEs 122, the RAN 102, and components of the core network 104. In one or more embodiments, some or all of the components of the core network 104 are implemented on a cloud computing system. In addition, one or more embodiments of the RAN components may be virtualized and/or otherwise implemented as part of a cloud computing system. In one or more embodiments, components of the RAN 102 and/or core network 104 may be implemented on an edge network that has virtual connections to the internal data center(s) (e.g., the data network 106) of the cloud computing system.

FIG. 2 illustrates additional detail with regard to the server device 108 and the components thereon. For example, as mentioned above, the server device 108 can include the combined subscriber data management function 118 having a plurality of respective components 202-208 implemented thereon). The combined subscriber data management function 118 multiplexes or combines an authentication component, a data management component, and a data repository component into a single component. Furthermore, the combined subscriber data management function 118 includes a communication interface manager 208. Additionally, the server device 108 includes the general storage functionality 120.

As shown in FIG. 2, the combined subscriber data management function 118 may receive a request 200 via the SMF to register the UE 122 with the core network and establish a network session. As used herein, the request 200 may include any request received from a UE which includes information about a source device, destination device, and/or any information about the service and/or operation being requested.

As just mentioned, the combined subscriber data management function 118 includes the authentication component 202 (e.g., an authentication server function or AUSF). In one or more implementations, the authentication component 202 includes one or more authentication functions. For example, the authentication component 202 can receive (e.g., via the SMF) requests to establish network sessions from UEs 122 within the telecommunications network as well as challenge responses from the UEs 122. Moreover, the authentication component 202 can request other information from additional components within the combined subscriber data management function 118 such as authentication challenges and keys associated with the authentication challenges. In at least one implementation, the authentication component 202 can transmit authentication challenges, as well as other messages to the UEs 122 that communicate connection status and session data.

As mentioned above, the combined subscriber data management function 118 includes the data management component 204 (e.g., a unified data management function or UDM). In one or more implementations, the data management component 204 manages the data that is used in various functions like session authorization, user registration, and so forth. As such, the data management component 204 can generate authentication challenges in response to requests to establish network sessions received by the authentication component 202. Moreover, the data management component 204 can compare challenge responses from UEs 122 against the generated authentication challenges to determine whether the challenge responses satisfy the authentication challenges.

As mentioned above, the combined subscriber data management function 118 includes the data repository component 206 (e.g., a unified data repository function or UDR as defined by 3GPP standards). In one or more implementations, the data repository component 206 is a database interface that stores and retrieves data according to one or more predefined schema. For example, the data repository component 206 can store and retrieve data from the general storage functionality 120 according to specific subscription data associated with the UE 122 that sends an authentication request to the authentication component 202.

In one or more implementations, one or more of the authentication component 202, the data management component 204, and the data repository component 206 may perform other tasks commonly associated with subscriber data management (SDM) related network functions. For example, other SDM-related functions may enable operators to store, track, and manage customer data effectively. As such, one or more of the components 202-206 may serve to identify which customers are subscribed to specific services and monitors their activity and service usage. These tasks often involve the performance of data management and repository tasks.

As mentioned above and as further shown in FIG. 2, the combined subscriber data management function 118 includes the communication interface manager 208. In one or more implementations, the communication interface manager 208 maintains internal communications between the authentication component 202, the data management component 204, and the data repository component 206 without any additional layers, controllers, or components.

Additionally, in one or more implementations, the communication interface manager 208 also functions as or otherwise facilitates an external communication interface for each of the authentication component 202, the data management component 204, and the data repository component 206. For example, depending on the session status between the core network 104 and the UE 122, the communication interface manager 208 can enable direct communication with one or more of the components of the combined subscriber data management function 118. In at least one implementation, the communication interface manager 208 maps and/or routes external communications to each of the authentication component 202, the data management component 204, and the data repository component 206 in a way that makes each of these components appear to be physically separated (e.g., not part of the same operating system process on the physical server device 108) from the perspective of external entities (e.g., the additional network functions 110 and/or the UEs 122). As such, the communication interface manager 208 ensures that external components require no updates or modifications to continue communicating with the components within the combined subscriber data management function 118.

Furthermore, in at least one implementation, the communication interface manager 208 can monitor communications to and from each of the authentication component 202, the data management component 204, and the data repository component 206 to enable metric tracking. For example, the communication interface manager 208 can monitor communications to and from the authentication component 202 and generate separate log files that include individual performance metrics associated with the authentication component 202. The communication interface manager 208 can then map log files (or other telemetry) onto a dashboard that reflects the number of session establishment requests over a period of time. The communication interface manager 208 further performs similar monitoring, logging, and mapping for the data management component 204 and the data repository component 206. In one or more implementations, the communication interface manager 208 enables metric tracking as another way of logically separating the components of the combined subscriber data management function 118 even though they are combined into the same operating system process on the same server device 108.

In one or more implementations, a controlling layer associated with the server device 108 can handle tasks associated with scalability relative to the combined subscriber data management function 118. As discussed above, combining the authentication component 202, the data management component 204, and the data repository component 206 into the communication interface manager 208 is advantageous because all three components have similar scalability limitations. As such, scaling one component within the combined subscriber data management function 118 often has an impact on the other two components. As such, the controlling layer of the server device 108 can scale the combined subscriber data management function 118, which in turn enables component-specific communication functionality within the overall combined subscriber data management function 118 communication interface to be quickly and easily updated.

When larger scaling is needed, the controlling layer of the server device 108 can determine when an additional combined subscriber data management function 118 needs to be deployed. For example, the controlling layer of the server device 108 can determine that additional subscriber management capacity is needed within the core network 104. In response to this determination, the controlling layer of the server device 108 can scale subscriber management capacity by deploying an additional combined subscriber data management function 118 that includes an additional authentication component, an additional data management component, and an additional data repository component. In one or more implementations, the controlling layer of the server device 108 can deploy the additional combined subscriber data management function 118 on the server device 108 or on a new or different server device within the core network 104.

Furthermore, as shown in FIG. 2, the server device 108 includes the general storage functionality 120. In one or more implementations, the general storage functionality 120 has shared dependencies with each of the authentication component 202, the data management component 204, and the data repository component 206. For example, each component of the combined subscriber data management function 118 may access and store different types of data within the general storage functionality 120.

As mentioned above, the combined subscriber data management function 118 combines the authentication component 202, the data management component 204, and the data repository component 206 into a single component (e.g., on the server device 108) while maintaining a logical separation between the functionalities of all three components.

FIG. 3 provides additional detail in connection with a diagram showing how the components of the combined subscriber data management function 118 function as part of an example authentication process between the UE 122 and the core network 104. In one or more implementations, the components of the combined subscriber data management function 118 perform the authentication according to the 5G-AKA authentication method (Authentication and Key Agreement). In additional implementations, the components of the combined subscriber data management function 118 perform the authentication steps as part of other methods such as EAP-AKA’ (Extensible Authentication Protocol – AKA Prime) or EAP-TLS (Extensible Authentication Protocol – Transport Layer Security).

As shown in FIG. 3, the authentication component 202 of the combined subscriber data management function 118 receives a request to register with the core network and establish a network session from the UE 122 in an act 302 (e.g., via the SMF, not shown). In one or more implementations, the request includes an identifier associated with the UE 122 (e.g., SUCI or 5G-GUTI) and is receive via direct communication from the UE 122. In response to receiving this request, the authentication component 202 can generate and transmit a request for an authentication challenge in an act 304. In at least one implementation, the authentication component 202 can transmit the request for the authentication challenge to the data management component 204.

The data management component 204 can begin generating the authentication challenge by requesting a unique key (e.g., a unique session identifier) from the data repository component 206 in an act 306. In response to receiving this request, the data repository component 206 can identify the requested information for a network session involving the UE 122 in an act 308. The data repository component 206 further transmits the information (e.g., the unique key) to the data management component 204 in an act 310.

With the unique key provided by the data repository component 206, the data management component 204 can generate the authentication challenge as well as the expected authentication response (AUTN) in an act 312. For example, the data management component 204 can generate the authentication challenge and the expected authentication response based on the unique key received from the data repository component 206. The data management component 204 can further provide the newly generated authentication challenge to the authentication component 202 in an act 314.

Upon receiving the authentication challenge from the data management component 204 the authentication component 202 can transmit the authentication challenge to the UE 122 in an act 316. The UE 122 can generate a challenge response to the authentication challenge in an act 320 based on the authentication challenge and secret key known to the UE 122. The UE 122 can further provide the challenge response back to the authentication component 202 in an act 322 via a direct communication. To determine whether the challenge response from the UE 122 is correct, the authentication component 202 can provide the challenge response to the data management component 204 in an act 324 where the data management component 204 compares the challenge response to the expected authentication response in an act 326.

Based on whether or not the challenge response correctly correlates with the expected authentication response, the data management component 204 can register the UE 122 with the core network, as well as generate and transmit a communication granting the network session in an act 328. The authentication component 202 can further transmit this communication to the UE 122 in an act 330. At this point, the network session is established and the UE 122 can communicate with all of the components of the 118—as well as other components within the core network 104 without the authentication component 202 acting as gatekeeper.

For example, at some point after the network session is established, the UE 122 can generate a data request in an act 332. Because the network session is established, the UE 122 can transmit the data request directly to the data management component 204 and/or any other component of the combined subscriber data management function 118 or other network function (e.g., the additional network functions 110 shown in FIG. 1) in an act 334. The data management component 204 can process the data request in an act 336 and request the data from the data repository component 206 in an act 338.

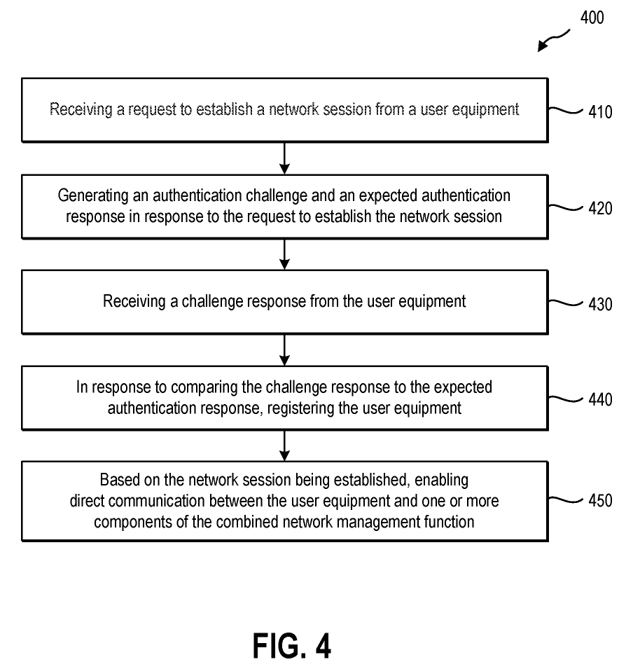

Turning now to FIG. 4, this figure illustrates an example flowchart including a series of acts featuring the combined functionality of the authentication component 202, the data management component 204, and the data repository component 206 within the combined subscriber data management function 118. While FIG. 4 illustrates acts according to one or more embodiments, alternative embodiments may omit, add to, reorder, and/or modify any of the acts shown in FIG. 4. The acts of FIG. 4 can be performed as part of a method. Alternatively, a non-transitory computer-readable medium can include instructions that, when executed by one or more processors, cause a computing device to perform the acts of FIG. 4. In still further embodiments, a system can perform the acts of FIG. 4.

FIG. 4 illustrates an example series of acts 400 related to authenticating a network session between the UE 122 and the core network 104 utilizing the combined functionality of the combined subscriber data management function 118. As shown in FIG. 4, the series of acts 400 includes an act 410 of receiving a request to establish a network session from a user equipment. In one or more embodiments, the act 410 includes receiving, by an authentication component of the combined subscriber data management function (e.g., the authentication component 202 of the combined subscriber data management function 118) via a subscriber management function of a core network, a request to establish a network session via direct communication from a user equipment. For example, as discussed above, the request can include information identifying the UE 122 as well as other information about the requested network session that would be needed to register the UE 122 with the core network 104.

As further shown in FIG. 4, the series of acts 400 includes an act 420 of generating an authentication challenge and an expected authentication response in response to the request to establish the network session. In one or more embodiments, the act 420 includes generating, by a data management component of the combined subscriber data management function (e.g., the data management component 204 of the combined subscriber data management function 118), an authentication challenge and an expected authentication response based on a key stored by a data repository component of the combined subscriber data management function (e.g., the data repository component 206 of the combined subscriber data management function 118) and in response to the request to establish the network session. For example, as discussed above, the data management component 204 can generate the authentication challenge and the expected authentication response based on a key that is unique to the UE 122.

As further shown in FIG. 4, the series of acts 400 includes an act 430 of receiving a challenge response from the user equipment. In one or more embodiments, the act 430 includes receiving, by the authentication component of the combined subscriber data management function and in response to transmitting the authentication challenge to the user equipment, a challenge response via direct communication from the user equipment. For example, as discussed above, upon receiving the authentication challenge, the UE 122 can generate the challenge response based on its unique key. In this way, the unique key becomes a way that the UE 122 and the core network 104 identify themselves to each other.

As further shown in FIG. 4, the series of acts 400 includes an act 440 of, in response to comparing the challenge response to the expected authentication response, registering the user equipment. In one or more embodiments, the act 440 includes, in response to comparing the challenge response to the expected authentication response, registering the user equipment to establish the network session. For example, the data management component 204 can compare the challenge response and the expected authentication response to determine whether they are identical, whether they are sufficiently similar, whether they both contain one or more predetermined markers, and/or so forth.

As further shown in FIG. 4, the series of acts 400 includes an act 450 of, based on the network session being established, enabling direct communication between the user equipment and one or more components of the combined subscriber data management function. In one or more embodiments, the act 450 includes, based on the network session being established, enabling direct communication between the user equipment and one or more of the data management component of the combined subscriber data management function and the data repository component of the combined subscriber data management function. For example, as discussed above, the combined subscriber data management function 118 may not allow direct communication with any other component beyond the authentication component 202 until the network session is established. Once the network session is established, the combined subscriber data management function 118 may allow direct communication with the other components via the combined communication interface that maintains a logical separation between the authentication component 202, the data management component 204, and the data repository component 206 even though these components are combined within the combined subscriber data management function 118. Moreover, once the UE 122 is registered with the core network via the process illustrated in FIG. 3, the combined subscriber data management function 118 enables the UE 122 to directly communication with any other component of the core network 104 (e.g., such as the additional network functions 110 illustrated in FIG. 1).

While the respective components of the combined subscriber data management function 118 may refer to services with authentication, data management, and data repository functionality generally, in one or more embodiments, the respective components have functionality corresponding to specific telecommunication standards. For example, in one or more embodiments, the authentication component has functionality of an authentication server function (AUSF) as defined by 3GPP standards. IN one or more embodiments, the data management component has functionality of a united data management function (UDM) as defined by 3GPP standards. In one or more embodiments, the data repository component has functionality of a unified data repository function (UDR) as defined by 3GPP standards

FIG. 5 illustrates certain components that may be included within a computer system 500. One or more computer systems 500 may be used to implement the various devices, components, and systems described herein.

The computer system 500 includes a processor 501. The processor 501 may be a general-purpose single- or multi-chip microprocessor (e.g., an Advanced RISC (Reduced Instruction Set Computer) Machine (ARM)), a special purpose microprocessor (e.g., a digital signal processor (DSP)), a microcontroller, a programmable gate array, etc. The processor 501 may be referred to as a central processing unit (CPU). Although just a single processor 501 is shown in the computer system 500 of FIG. 5, in an alternative configuration, a combination of processors (e.g., an ARM and DSP) could be used.

The computer system 500 also includes memory 503 in electronic communication with the processor 501. The memory 503 may be any electronic component capable of storing electronic information. For example, the memory 503 may be embodied as random-access memory (RAM), read-only memory (ROM), magnetic disk storage media, optical storage media, flash memory devices in RAM, on-board memory included with the processor, erasable programmable read-only memory (EPROM), electrically erasable programmable read-only memory (EEPROM) memory, registers, and so forth, including combinations thereof.

Instructions 505 and data 507 may be stored in the memory 503. The instructions 505 may be executable by the processor 501 to implement some or all of the functionality disclosed herein. Executing the instructions 505 may involve the use of the data 507 that is stored in the memory 503. Any of the various examples of modules and components described herein may be implemented, partially or wholly, as instructions 505 stored in memory 503 and executed by the processor 501. Any of the various examples of data described herein may be among the data 507 that is stored in memory 503 and used during execution of the instructions 505 by the processor 501.

A computer system 500 may also include one or more communication interfaces 509 for communicating with other electronic devices. The communication interface(s) 509 may be based on wired communication technology, wireless communication technology, or both. Some examples of communication interfaces 509 include a Universal Serial Bus (USB), an Ethernet adapter, a wireless adapter that operates in accordance with an Institute of Electrical and Electronics Engineers (IEEE) 802.11 wireless communication protocol, a Bluetooth^{®} wireless communication adapter, and an infrared (IR) communication port.

A computer system 500 may also include one or more input devices 511 and one or more output devices 513. Some examples of input devices 511 include a keyboard, mouse, microphone, remote control device, button, joystick, trackball, touchpad, and lightpen. Some examples of output devices 513 include a speaker and a printer. One specific type of output device that is typically included in a computer system 500 is a display device 515. Display devices 515 used with embodiments disclosed herein may utilize any suitable image projection technology, such as liquid crystal display (LCD), light-emitting diode (LED), gas plasma, electroluminescence, or the like. A display controller 517 may also be provided, for converting data 507 stored in the memory 503 into text, graphics, and/or moving images (as appropriate) shown on the display device 515.

The various components of the computer system 500 may be coupled together by one or more buses, which may include a power bus, a control signal bus, a status signal bus, a data bus, etc. For the sake of clarity, the various buses are illustrated in FIG. 5 as a bus system 519.

The techniques described herein may be implemented in hardware, software, firmware, or any combination thereof, unless specifically described as being implemented in a specific manner. Any features described as modules, components, or the like may also be implemented together in an integrated logic device or separately as discrete but interoperable logic devices. If implemented in software, the techniques may be realized at least in part by a non-transitory processor-readable storage medium comprising instructions that, when executed by at least one processor, perform one or more of the methods described herein. The instructions may be organized into routines, programs, objects, components, data structures, etc., which may perform particular tasks and/or implement particular data types, and which may be combined or distributed as desired in various embodiments.

The steps and/or actions of the methods described herein may be interchanged with one another without departing from the scope of the claims. In other words, unless a specific order of steps or actions is required for proper operation of the method that is being described, the order and/or use of specific steps and/or actions may be modified without departing from the scope of the claims.

The term “determining” encompasses a wide variety of actions and, therefore, “determining” can include calculating, computing, processing, deriving, investigating, looking up (e.g., looking up in a table, a database or another data structure), ascertaining and the like. Also, “determining” can include receiving (e.g., receiving information), accessing (e.g., accessing data in a memory) and the like. Also, “determining” can include resolving, selecting, choosing, establishing and the like.

The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional embodiments that also incorporate the recited features. For example, any element or feature described in relation to an embodiment herein may be combinable with any element or feature of any other embodiment described herein, where compatible.

The present disclosure may be embodied in other specific forms without departing from its spirit or characteristics. The described embodiments are to be considered as illustrative and not restrictive. The scope of the disclosure is, therefore, indicated by the appended claims rather than by the foregoing description. Changes that come within the meaning and range of equivalency of the claims are to be embraced within their scope.

What is claimed is:

1. In a telecommunications network including a combined subscriber data management function having a plurality of network management components, a method for managing a network session comprising:
receiving, by an authentication component of the combined subscriber data management function via a subscriber management function of a core network, a request to establish a network session via direct communication from a user equipment;
generating, by a data management component of the combined subscriber data management function, an authentication challenge and an expected authentication response based on a key stored by a data repository component of the combined subscriber data management function and in response to the request to establish the network session;
receiving, by the authentication component of the combined subscriber data management function and in response to transmitting the authentication challenge to the user equipment, a challenge response via direct communication from the user equipment;
in response to comparing the challenge response to the expected authentication response, registering the user equipment with the core network to establish the network session; and
based on the network session being established, enabling direct communication between the user equipment and one or more of the data management component of the combined subscriber data management function and the data repository component of the combined subscriber data management function.

2. The method of claim 1, wherein the authentication component, the data management component, and the data repository component of the combined subscriber data management function are multiplexed onto a single operating system process of a server.

3. The method of claim 2, wherein the authentication component, the data management component, and the data repository component of the combined subscriber data management function communicate directly within the combined subscriber data management function without any messaging that is external to the server.

4. The method of claim 1, wherein the combined subscriber data management function further includes separate external communication interfaces for each of the authentication component, the data management component, and the data repository component.

5. The method of claim 4, wherein the separate external communication interfaces cause the authentication component, the data management component, and the data repository component to appear as separate components to the user equipment.

6. The method of claim 4, wherein the separate external communication interfaces cause the authentication component, the data management component, and the data repository component to appear as separate components to other network functions within a core network of the telecommunications network.

7. The method of claim 5, wherein the separate external communication interfaces further cause the authentication component, the data management component, and the data repository component to generate separate log files that include individual performance metrics associated with each of the authentication component, the data management component, and the data repository component.

8. The method of claim 1, wherein the authentication component, the data management component, and the data repository component of the combined subscriber data management function access a single general storage functionality.

9. The method of claim 1, wherein the data management component and the data repository component of the combined subscriber data management function are inaccessible by the user equipment until the network session is established.

10. The method of claim 1, further comprising:
determining that additional subscriber management capacity is needed; and
scaling subscriber management capacity by deploying an additional combined subscriber data management function including an additional authentication component, an additional data management component, and an additional data repository component.

11. The method of claim 1,
wherein the authentication component has functionality of an authentication server function (AUSF) as defined by 3GPP standards,
wherein the data management component has functionality of a united data management function (UDM) as defined by 3GPP standards, and
wherein the data repository component has functionality of a unified data repository function (UDR) as defined by 3GPP standards.

12. The method of claim 1, wherein the combined subscriber data management function is part of a core network of a fifth generation (5G) mobile communication network.

13. A system comprising:
at least one processor;
memory in electronic communication with the at least one processor; and
instructions stored in the memory, the instructions being executable by the at least one processor to:
receive, by an authentication component of a combined subscriber data management function via a subscriber management function of a core network, a request to establish a network session via direct communication from a user equipment;
generate, by a data management component of the combined subscriber data management function, an authentication challenge and an expected authentication response based on a key stored by a data repository component of the combined subscriber data management function and in response to the request to establish the network session;
receive, by the authentication component of the combined subscriber data management function and in response to transmitting the authentication challenge to the user equipment, a challenge response via direct communication from the user equipment;
in response to comparing the challenge response to the expected authentication response, register the user equipment with the core network to establish the network session; and
based on the network session being established, enable direct communication between the user equipment and one or more of the data management component of the combined subscriber data management function and the data repository component of the combined subscriber data management function.

14. The system of claim 13, wherein the authentication component, the data management component, and the data repository component of the combined subscriber data management function are multiplexed onto a single operating system process of a server.

15. The system of claim 14, wherein the authentication component, the data management component, and the data repository component of the combined subscriber data management function communicate directly within the combined subscriber data management function without any messaging that is external to the server.

16. The system of claim 13, wherein the combined subscriber data management function further includes separate external communication interfaces for each of the authentication component, the data management component, and the data repository component.

17. The system of claim 16, wherein the separate external communication interfaces cause the authentication component, the data management component, and the data repository component to appear as separate components to the user equipment.

18. The system of claim 16, wherein the separate external communication interfaces cause the authentication component, the data management component, and the data repository component to appear as separate components to other network functions within a core network of a telecommunications network.

19. The system of claim 18, wherein the separate external communication interfaces further cause the authentication component, the data management component, and the data repository component to generate separate log files that include individual performance metrics associated with each of the authentication component, the data management component, and the data repository component.

20. In a fifth generation (5G) mobile communication network including a combined subscriber data management function having a plurality of network management components, a method for managing a network session comprising:
receiving, by an authentication component of the combined subscriber data management function via a subscriber management function of a core network, a request to establish a network session via direct communication from a user equipment;
generating, by a data management component of the combined subscriber data management function, an authentication challenge and an expected authentication response based on a key stored by a data repository component of the combined subscriber data management function and in response to the request to establish the network session;
receiving, by the authentication component of the combined subscriber data management function and in response to transmitting the authentication challenge to the user equipment, a challenge response via direct communication from the user equipment; and
in response to comparing the challenge response to the expected authentication response, registering the user equipment with the core network to establish the network session.
